(19) United States
(12) Patent Application Publication
(10) Pub. No.: US 2026/0128701 A1
(43) Pub. Date: May 7, 2026

(54) LAWN AND GARDEN POWER TOOL INCLUDING ELECTRIC MOTOR WITH TWO SELECTABLE POWER OUTPUTS

(71) Applicant: Honda Motor Co., Ltd., Tokyo (JP)

(72) Inventor: Toshiyuki HASEGAWA, Durham, NC (US)

(21) Appl. No.: 18/937,671

(22) Filed: Nov. 5, 2024

(51) Int. Cl. H02P 25/18; A01D 34/00; A01D 34/68; A01D 34/78; A01D 34/82; A01D 101/00; H02K 16/04

(52) U.S. Cl. CPC H02P 25/184; A01D 34/006; A01D 34/68; A01D 34/78; H02K 16/04; A01D 34/824; A01D 2101/00

(57) ABSTRACT

A lawn and garden power tool can include a battery, an electric motor, a shaft driven by the motor, an implement drive by the shaft, and a controller. The motor can include a rotor and two stator cores. A first coil can be wound on the first stator core and a second coil can be wound on the second stator core. The controller can be configured to selectively cause the motor to operate in a first output mode in which the battery pack is electrically connected to the first coil and the second coil based on a first predetermined condition, and the first coil is electrically connected in series with the second coil; and selectively cause the motor to operate in a second output mode in which the battery pack is electrically disconnected from the second coil and electrically connected to the first coil based on a second predetermined condition.

### BACKGROUND

The disclosed subject matter relates to an electrically powered lawn and garden power tool. More particularly, the disclosed subject matter relates to a battery-powered lawn and garden tool that includes an electric motor that has two selectable power outputs.

Power equipment (also referred to as power tools) can be used to remove snow, generate electric power, pump water, or manicure vegetation of a landscaped area. The power equipment can be a handheld device, or supported by at least one wheel. When used to manicure the vegetation of a landscaped area, the power equipment can include a cutting implement such as a rotating spool of nylon string, a rotary blade, or a reciprocating blade. The cutting implement can be driven by an internal combustion engine or an electric motor. When used to remove snow, the power equipment can include an auger that is driven by the engine or electric motor.

### SUMMARY

Some embodiments are directed to a lawn and garden power tool that can include a battery, an electric motor, a shaft, an implement and a controller. The electric motor can include a housing, a rotor, a first stator core, a first coil, a second stator core and a second coil. The rotor can be supported by the housing and rotatable relative to the housing about a rotational axis. The first stator core and the second stator core can be fixed to the housing and located about the rotor. The second stator core can be stacked relative to the first stator core along the rotational axis. The first coil can be wound on the first stator core and the second coil can be wound on the second stator core. The shaft can be connected to and driven by the rotor, and the implement can be driven by the shaft. The controller can be in electrical communication with the battery and configured to: if the controller receives a first operational request, cause the motor to operate in a first output mode in which the battery pack is electrically connected to the first coil and the second coil, and the first coil is electrically connected in series with the second coil; and if the controller receives a second operational request that is different from the first operational request, cause the motor to operate in a second output mode in which the battery pack is electrically disconnected from the second coil and electrically connected to the first coil.

Some embodiments are directed to a lawn and garden power tool that can include a battery, an electric motor, a shaft, a user input and a controller. The electric motor can include a housing, a rotor, a first stator core, a first coil, a second stator core and a second coil. The rotor can be supported by the housing and rotatable relative to the housing about a rotational axis. The first stator core and the second stator core can be fixed to the housing and located about the rotor. The second stator core can be stacked relative to the first stator core along the rotational axis. The first coil can be wound on the first stator core and the second coil can be wound on the second stator core. The shaft can be connected to and driven by the rotor and configured to drive an implement. The user input can be configured to output a selected one of a first operational request, a second operational request, and a third operational request. The controller can be in electrical communication with the battery and configured to: if the controller receives the first operational request, cause the electric motor to operate in a first output mode in which the battery pack is electrically connected in to the first coil and the second coil, and the first coil is electrically connected in series with the second coil; if the controller receives the second operational request that is different from the first operational request, cause the electric motor to operate in a second output mode in which the battery pack is electrically disconnected from the second coil and electrically connected to the first coil; and if the controller receives the third operational request that is different from the first operational request and the second operational request, cause the electric motor to: operate in the first output mode if a sensed variable has a first relationship to a predetermined threshold; and operate in the second output mode if the sensed variable has a second relationship to the predetermined threshold, the second relationship is different from the first relationship.

Some embodiments are directed to a lawn and garden power tool that can include a battery, an electric motor, a shaft and a controller. The electric motor can include a housing, a rotor, a first stator core, a first coil, a second stator core and a second coil. The rotor can be located adjacent the housing and rotatable relative to the housing about a rotational axis. The first stator core and the second stator core can be located about the rotor, and the second stator core can be stacked relative to the first stator core along the rotational axis such that the first stator core is located at a first position along the rotational axis and the second stator core is located at a second position different from the first position along with rotational axis. The first coil can be wound on the first stator core and the second coil can be wound on the second stator core. The shaft can be connected to and driven by the rotor and configured to drive an implement. The controller can be in electrical communication with the battery and configured to: if the controller is subject to a first operational request, cause the motor to operate in a high power mode in which the battery pack is electrically connected to the first coil and the second coil; and if the controller is subject to a second operational request that is different from the first operational request, cause the motor to operate in a low power mode in which the battery pack is electrically disconnected from the second coil and electrically connected to the first coil.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a perspective view of a lawn and garden power tool made in accordance with principles of the disclosed subject matter.

FIG. 2 is an exploded perspective view of a power source assembly of the lawn and garden power tool of FIG. 1.

FIG. 3 is perspective view an electric motor of the lawn and garden power tool of FIG. 1.

FIG. 4 is a perspective view the electric motor of FIG. 3 with the upper housing and lower housing omitted.

FIG. 5 is a perspective view of a rotor and a first stator of the electric motor of FIG. 3.

FIG. 6 is a perspective view the rotor and a second stator of the electric motor of FIG. 3.

FIG. 7 is cross-sectional view taken along line 7-7 of FIG. 3.

FIG. 8 is a schematic view of a high power mode of the electric motor of FIG. 3.

FIG. 9 is a schematic view of a low power mode of the electric motor of FIG. 3.

FIG. 10 is a schematic view of a first embodiment of a torque switching motor control system of the lawn and garden power tool of FIG. 1.

FIG. 11 is a graph showing respective plots of torque versus speed for the lawn and garden power tool when the torque switching motor control system operates the electric motor in the high power mode or in the low power mode.

FIG. 12 is a flow chart showing an algorithm for the torque switching motor control system of the lawn and garden power tool of FIG. 1.

FIG. 13 is a schematic view of a second embodiment of a torque switching motor control system for a lawn and garden power tool.

FIG. 14 is a schematic view of a third embodiment of a torque switching motor control system for a lawn and garden power tool.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

Power equipment configured as any one of, but not limited to, a lawnmower, a snow blower, a tiller, a leaf blower, a hedge trimmer, a string trimmer, and a pruning saw, can be referred to as a lawn and garden power tool. The lawn and garden power tool can include an implement, at least one electric motor, and a rechargeable battery that supplies electric power to the electric motor. The electric motor can drive the implement such as, but not limited to, a rotating spool of nylon string (also referred to as trimmer line), a rotary blade, a reciprocating blade, or an auger. The electric motor can be a direct current (DC) motor or an alternating current (AC) motor.

The electric motor of the lawn and garden power tool can be specified with a predetermined rated power output based on the task(s) intended for the lawn and garden power tool. However, the predetermined rated power output for the electric motor may be excessive for some tasks actually performed by the lawn and garden power tool and insufficient for other tasks actually performed by the lawn and garden power tool. For, example, the power used to cut grass of a given lawn area can vary as any of the density, height and moisture of the grass varies during the growing season. It is possible that the motor power output might be insufficient for a dense, tall, damp lawn and/or excessive for a sparse dry lawn.

In another example, the lawn and garden power tool can be configured as a lawnmower that is used by a commercial mowing service. It could be beneficial to the commercial mowing service to operate the blade motor at the highest possible rotational speed to minimize time spent at each job site. However, the torque output by the motor can decrease as the speed increases. Thus, increasing the rotational speed of the motor for a lush, dense, moist lawn can adversely impact the cutting effectiveness of the blade due to the relative decrease in torque that the blade motor outputs to the blade.

Accordingly, it can be beneficial to provide an electric-powered lawn and garden power tool that can permit the user to vary the power output by the electric motor based on the performance of the lawn and garden power tool that is desired by the operator.

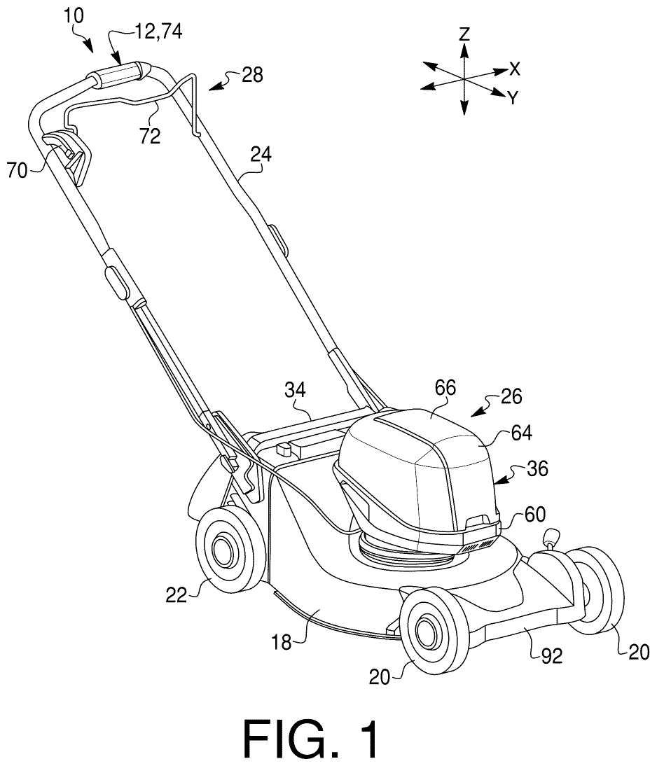

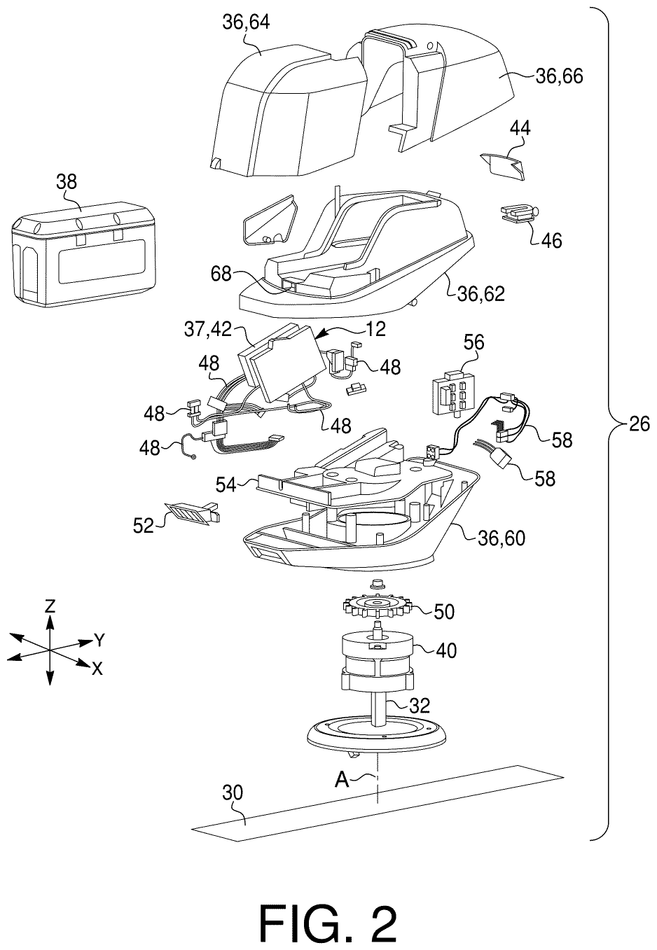

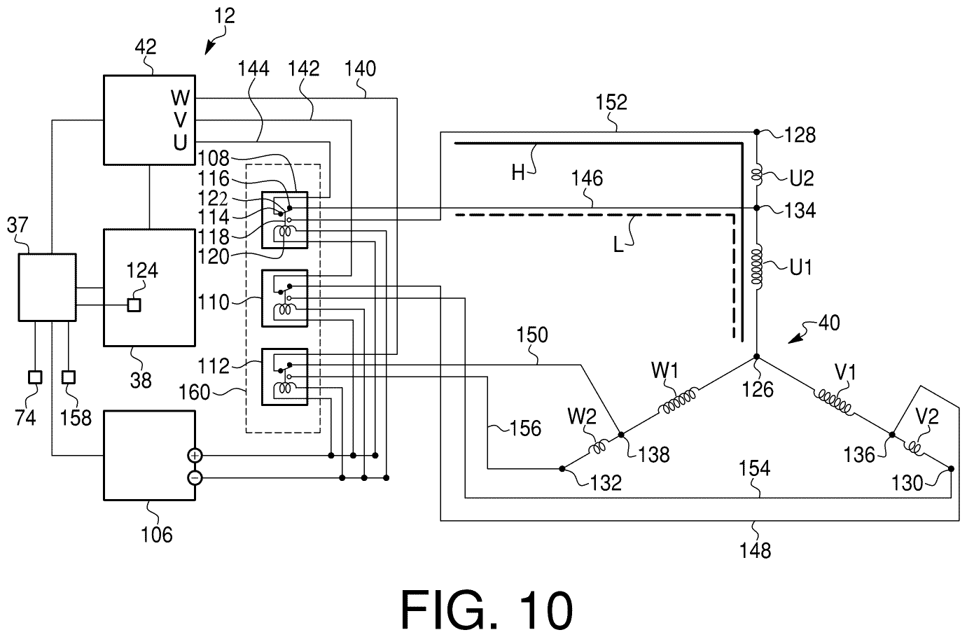

FIG. 1 illustrates an embodiment of a lawn and garden power tool 10 made in accordance with principles of the disclosed subject matter. Referring FIGS. 2 and 10, the lawn and garden power tool 10 can include a battery pack 38, an electric motor 40 and a torque switching motor control system 12 that can vary the operation of the electric motor 40 between a high power mode and a low power mode. The high power mode (also referred to as a POWER mode) can be advantageous when the operator desires to complete the task in a relatively short time or to cut vegetation that is dense, thick, and/or damp. The low power mode (also referred to as an ECO mode) can be advantageous when the operator desires to complete the task with a relatively small consumption of electric power and achieve a relatively long runtime for the lawn and garden power tool 10 for each full charge of the battery pack 38.

The lawn and garden power tool 10 can be configured as, but not limited to, a lawnmower, a snow blower, a tiller, a hedge trimmer, a string trimmer, and a pruning saw. The lawn and garden power tool 10 of FIG. 1 is configured as a walk-behind lawnmower. The lawnmower 10 can include a cutter housing 18, a pair of front wheels 20, a pair of rear wheels 22, a handle 24, a power source assembly 26 and a control system 28. The rear wheel 22 on the left side of the lawnmower 10 is obstructed from view in FIG. 1 by the cutter housing 18.

Referring to FIG. 2, the power source assembly 26 can include the electric motor 40 and the lawnmower 10 can include a blade 30, as an implement, and a blade shaft 32 connected to each of the blade 30 and the electric motor 40. The blade 30 can be referred to as a cutting blade or a lawn mowing blade or a lawnmower blade. The electric motor 40 can be configured to selectively rotate the blade shaft 32 and the blade 30 in the cutter housing 18 about a blade axis A. The blade shaft 32 can be referred to as a component of the power source assembly 26. Alternatively, the blade shaft 32 can be referred to as a component that is connected to and driven by the power source assembly 26.

The lawnmower 10 can be described with respect to a coordinate system that includes an X-direction, a Y-direction and a Z-direction that are orthogonal to each other. The Z-direction can be parallel to the blade axis A.

The cutter housing 18 can be referred to as a mower deck or as a cutter deck or as a deck. Returning to FIG. 1, the cutter housing 18 can include an opening at a rear end 34 of the cutter housing 18. The lawnmower 10 can include a collection bag that can be selectively attached to and detached from the rear end 34. The opening and the collection bag are omitted for simplicity and clarity of the drawing. The collection bag can be in communication with the opening such that vegetation clippings produced by the blade 30 can be collected in the collection bag.

Returning to FIGS. 2 and 10 collectively, the power source assembly 26 can include a housing 36, the battery pack 38, a controller 37, a motor driver 42, an LED display 44, a terminal block 46, a motor wire harness 48, a fan 50, a headlight assembly 52, a duct plate 54, a transmission controller 56, a transmission wire harness 58 and the control system 28 (FIG. 1). The housing 36 can contain the battery pack 38, the electric motor 40 the blade motor driver 42, the wire harnesses 48, 58, the fan 50 and the duct plate 54.

The control system 28 can provide the operator of the lawnmower 10 the ability to make inputs during use of the lawnmower 10. The control system 28 can include a wake button 70, a blade brake lever 72, and a mode selector 74.

The controller 37 can be configured to operate in a sleep mode if the lawnmower 10 remains unused for a predetermined time. In the sleep mode, the controller 37 can be configured to consume no power or a minimum amount of power to support operation(s) performed by the controller 37 during the sleep mode. The wake button 70 can be a push button that outputs a wake signal if an operator of the lawnmower 10 depresses the wake button 70. The controller 37 can be configured to receive the signal output by the wake button 70 and exit sleep mode and stand by for inputs from the operator.

The blade brake lever 72 can output a blade OFF signal if the lever 72 is in the position shown in FIG. 1. The blade brake lever 72 can output a blade ON signal if the blade brake lever 72 is moved onto or immediately adjacent to the portion of the handle 24 that is gripped by the operator during use of the lawnmower 10. The controller 37 can be configured to signal the motor driver 42 to output power to the electric motor 40 if the controller 37 receives the blade ON signal and signal the blade motor driver 42 to stop the output of power to the electric motor 40 if the controller receives the blade OFF signal.

The mode selector 74 can be used by the operator of the lawnmower to signal the controller 37 to operate the electric motor 40 in any of the high power mode, the low power mode or a switching mode. The mode selector 74 can be any appropriate device such as, but not limited to, a multi-position switch, a rotary dial, or a touch screen, that can permit the user to select the high power mode, the low power mode, or the switching mode. If the user selects the switching mode, the controller 37 can be configured to automatically switch between the high power mode and the low power mode based on one or more predetermined (or sensed) conditions of the lawnmower 10 and/or at least one condition of the vegetation of the lawn area.

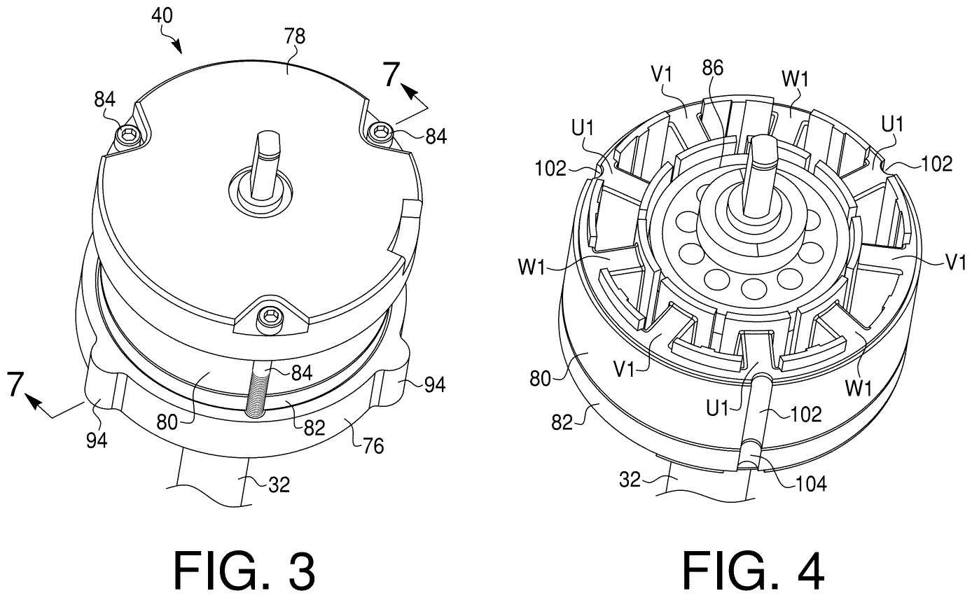

Referring to FIG. 3, the blade motor 40 can include a base 76, a cover 78, a first stator 80, a second stator 82 and plurality of bolts 84 that connect the base 76, the cover 78 and the stators 80, 82 to each other. The base 76 and the cover 78 can be referred to collectively as a housing.

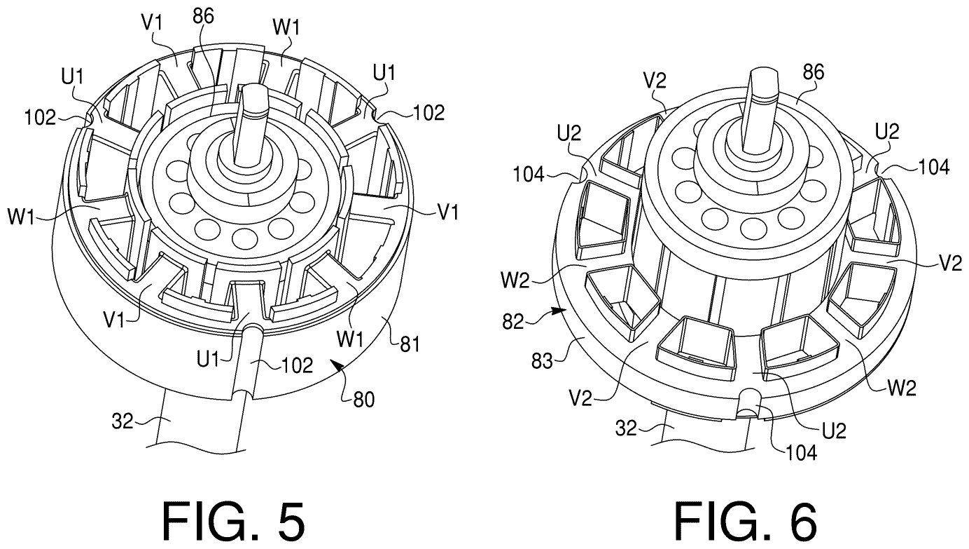

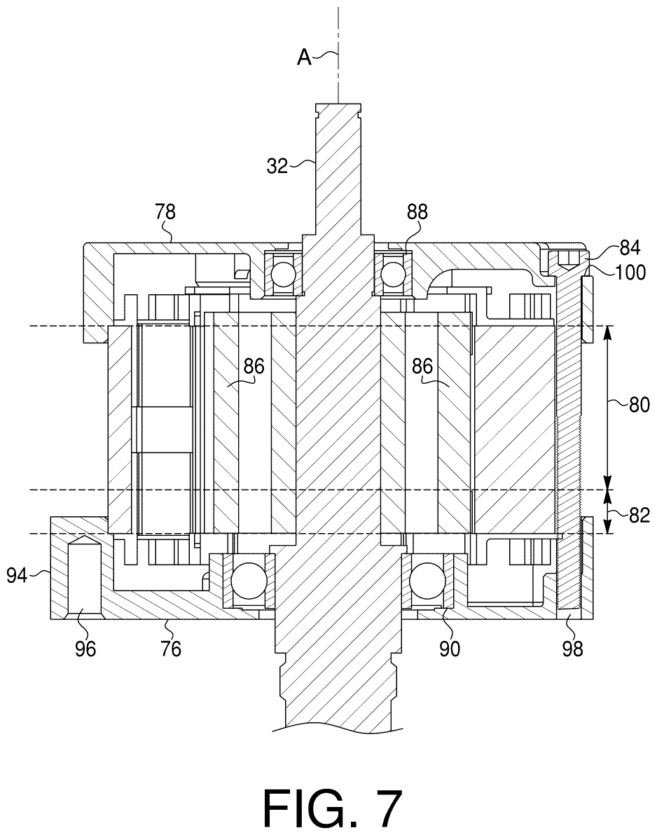

Referring to FIGS. 4-7, the electric motor 40 can include a rotor 86 that is rotatable relative to the housing 76, 78 and the stators 80, 82 about the blade axis A. FIG. 4 shows the rotor 86 and the stators 80, 82 with the base 76 and the cover 78 removed. FIG. 5 shows rotor 86 and the first stator 80 with the second stator removed and FIG. 6 shows the second stator 82 with the first stator removed. The stators 80, 82 can be located about the rotor 86. In exemplary embodiments, the rotor 86 and the stators 80, 82 can be generally cylindrical in shape and concentric with the blade axis A. The rotor 86 can include a plurality of permanent magnets spaced in a circumferential direction about the rotor 86.

Referring to FIGS. 3-7, the electric motor 40 can include a first bearing 88 and a second bearing 90. The blade shaft 32 can be fixed to the rotor 86 by any appropriate manner such as, but not limited to, a press-fit, splines, or a keyed connection, so that the blade shaft 32 rotates in unison with the rotor 86. The bearings 88, 90 can rotatably support the rotor in the cover 78 and the base 76. The rotor 86 can be rotated about the blade axis A.

The controller 37 can be configured to operate the electric motor 40 in the low power mode by causing power from the battery pack 38 to bypass the second stator 82 and flow through the first stator 80. The controller 37 can be configured operate the electric motor 40 in the high power mode by causing power from the battery pack 38 to flow to the second stator 82 and the first stator 80 in a serial electrical connection.

Referring to FIG. 7, the electric motor 40 can include a plurality of bolts 84 that fix the base 76, the cover 78 and the stators 80, 82 to each other. The base 76 can include a plurality of first through holes 98 spaced about the perimeter of the base 76 and the cover 78 can include a plurality of second through holes 100 spaced about the perimeter of the cover 78. A respective bolt 84 can pass through a respective one of the first through holes 98 and extend into a respective one of the second through holes 100.

Referring to FIG. 3, the first stator 80 can include a plurality of first grooves 102 and the second stator 82 can include a plurality of second grooves 104. A respective one of the first grooves 102 can be aligned with a respective one of the second grooves 104 in a direction that is parallel to the blade axis A. A respective one of the bolts 84 can be seated in a respective one of the first grooves 102 and a respective one of the second grooves 104.

Referring to FIGS. 3 and 7, the base 76 can include a plurality of mounting fixtures 94 spaced about the perimeter of the base 76. Each of the mounting fixtures 94 can include a threaded blind bore 96. A respective bolt can pass through the cutter housing 18 and into a respective one of the threaded blind bores 96 to mount the blade motor 40 onto the cutter housing 18.

Referring to FIGS. 3-5, the electric motor 40 can be a three-phase direct current (DC) or alternating current (AC) electric motor. The motor driver 42 can be electrically connected to the battery pack 38 and configured to receive direct current (DC) power from the battery pack 38, convert the DC power received from the battery pack 38 into three-phase back electromotive force (Back EMF) same as AC power, and output the three-phase AC power to the electric motor 40. The motor driver 42 can include an inverter that has a plurality of power MOSFETs configured in any appropriate manner that can convert the battery's DC power into the three-phase AC power. The motor driver 42 can be configured to receive the blade ON signal and the blade OFF signal from the controller 37 and output the AC power if the motor driver 42 receives the blade ON signal and stop output of the AC if the motor driver 42 receives the blade OFF signal.

The three-phase AC power output by the motor driver 42 can include a U-phase (also referred to as a first phase or an A-phase), a V-phase (also referred to as a second phase or a B-phase), and a W-phase (also referred to as a third phase or a C-phase). Each of the phases U, V, W can have a generally sinusoidal variation in current that is out of phase with the other two phases.

Referring to FIGS. 4 and 5, the first stator 80 can include a first stator core 81 and a plurality of first U-phase windings U1, a plurality of first V-phase windings V1 and a plurality of first W-phase windings W1 wound on the first stator core 81. The first stator 80 can include three of each of the first windings U1, V1, W1 that alternate sequentially in the circumferential direction of the first stator 80. Each of the windings U1, V1, W1 can be wound on the first stator 80. The torque switching motor control system 12 can be configured to output the U-phase AC power to the first U-phase windings U1, the V-phase AC power to the first V-phase windings V1, and the W-phase AC power to the first W-phase windings W1 in both of the high power mode and the low power mode of the electric motor 40. The first windings U1, V1, W1 can be referred to collectively as a first coil and configured to output a first rated power of the electric motor 40.

Referring to FIG. 6, the second stator 82 can include a second stator core 83 and a plurality of second U-phase windings U2, a plurality of second V-phase windings V2 and a plurality of second W-phase windings W2 wound onto the second stator core 83. The second stator 82 can include three of each of the second windings U2, V2, W2 that alternate sequentially in the circumferential direction of the second stator 82. The torque switching motor control system 12 can be configured to output the U-phase AC power to the second U-phase windings U2, the V-phase AC power to the second V-phase windings V2, and the second W-phase AC power to the second W-phase windings W2 in the high power mode of the electric motor 40 and to bypass the second windings U2, V2, W2 in the low power mode of the electric motor 40. The second windings U2, V2, W2 can be referred to collectively as a second coil and configured to output an auxiliary power that is less than the first rated power of the electric motor 40. If the electric motor 40 operates in the high power mode, the auxiliary power can be combined with the first rated power to produce a second rated power output for the electric motor 40 that is greater than the first rated power output.

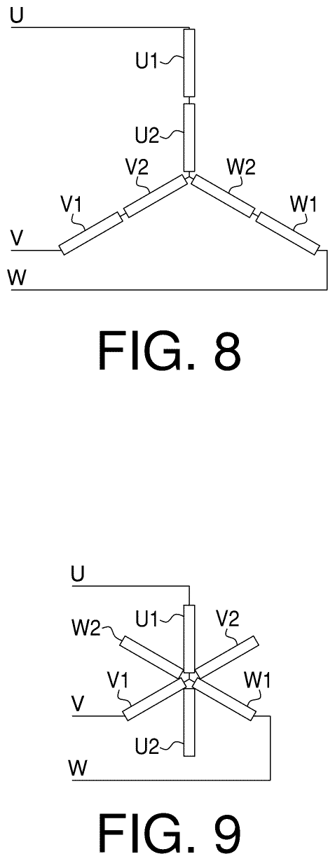

FIG. 8 schematically illustrates the high power mode of the electric motor 40 and FIG. 9 schematically illustrates the low power mode of the electric motor 40. In the high power mode of FIG. 8, the torque switching motor control system 12 can connect the second windings U2, V2, W2 in series with the first windings U1, V1, W1 and energize all of the windings U1, V1, W1, U2, V2, W2 with the three-phase AC power output by the motor driver 42. In the low power mode of FIG. 9, the torque switching motor control system 12 can bypass the second windings U2, V2, W2 and energize the first windings U1, V1, W1 with the three-phase AC power output by the motor driver 42.

For example, the first windings U1, V1, W1 can cause the electric motor 40 to operate at the first rated power of 1.5 kW and the second windings U2, V2, W2 can cause the electric motor 40 to operate at the auxiliary rated power of 0.5 kW. Thus, in the low power mode, the electric motor 40 can operate at the first rated power of 1.5 kW and in the high power mode, the blade motor 40 can operate at the second rated power of 2.0 kW.

Referring to FIG. 10, the torque switching motor control system 12 can include the controller 37, the electric motor 40, the mode selector 74, a relay driver 106, a plurality of relays 108, 110, 112 and a temperature sensor 124. FIG. 10 schematically illustrates the respective sets of windings U1, V1, W1, U2, V2, W2 shown in FIGS. 4-6 as a respective single coil U1, V1, W1, U2, V2, W2 for simplicity and clarity of the drawing.

The temperature sensor 124 can be any appropriate device such as, but not limited to, a thermocouple or a thermistor, that is configured to output a signal that is indicative of a temperature. The temperature sensor 124 can be thermally connected to any one of the batteries of the battery pack 38. In alternate embodiments, an array of temperature sensors 124 can be used in which a respective temperature sensor 124 is thermally connected to a respective one of the batteries of the battery pack 38.

The mode selector 74 can be electrically connected to the controller 37 and configured to output a signal that is indicative of one of the high power mode, low power mode, and the switching mode that has been selected by the operator of the lawnmower 10. The controller 37 can be configured to receive and discern the signal output by the mode selector 74 and output a control signal to the relay driver 106 that causes the relay driver 106 to control the relays 108, 110, 112 and operate the blade motor 40 in the appropriate one of the high power mode and the low power mode.

The relay driver 106 can be in electrical communication with the controller 37 and each of the relays 108, 110, 112. The controller 37 can be configured to send an ON signal or an OFF signal based on the signal the controller receives from the mode selector 74. The relay driver 106 can be configured to receive the ON signal or the OFF signal and selectively energize or de-energize the relays 108, 110, 112, respectively.

A respective one of the relays 108, 110, 112 can be connected in series between the electric motor 40 and a respective one of the phase outputs U, V, W of the motor driver 42. The first relay 108 can be configured to either supply the U-phase current to the second U-phase coil U2 in series with the first U-phase coil U1, or bypass the second U-phase coil U2 and supply the U-phase current to first U-phase coil U1. The second relay 110 can be configured to either supply the V-phase current to the second V-phase coil V2 in series with the first V-phase coil V1, or bypass the second V-phase coil V2 and supply the V-phase current to the first V-phase coil V1. The third relay 112 can be configured to either supply the W-phase current to the second W-phase coil W2 in series with the first W-phase coil W1, or bypass the second W-phase coil W2 and supply the W-phase current to the first W-phase coil W1. The relays 108, 110, 112 can be collectively referred to as a switch 160 or a relay array 160.

Each of the relays 108, 110, 112 can be referred to as a single-pole, double-throw relay and can include an input terminal 114, a first contact 116, a second contact 118, a relay coil 120 and a movable contact 122. The reference numbers 114, 116, 118 120, 122 are omitted from the second and third relays 110, 112 for clarity and simplicity of the drawing. Each of the relay coils 120 can be electrically connected to and selectively controlled by the relay driver 106.

The relay driver 106 can be configured to simultaneously energize the relay coil 120 of all of the relays 108, 110, 112 if the relay driver 106 receives the ON signal from the controller 37. The relay driver 106 can be configured to simultaneously de-energize the relay coil 120 of all of the relays 108, 110, 112 if the relay driver 106 receives the OFF signal from the controller 37.

Each of the relays 108, 110, 112 can include a biasing structure that biases the respective movable contact 122 to electrically connect the respective input terminal 114 to the respective first contact 116 when the respective relay coil 120 is de-energized. The movable contact 122 can be spaced away from the second contact 118 if the coil 120 is de-energized. The movable contact 122 can disengage from the first contact 116 and electrically connect to the second contact 118 if the relay driver 106 energizes the relay coil 120. FIG. 10 shows each of the relays 108, 110, 112 in the de-energized state.

The electric motor 40 can be wired in a wye configuration in which each of the windings U1, U2, V1, V2, W1, W2 is connected to a neutral 126. The electric motor 40 can include a plurality of terminal nodes 128, 130, 132 and a plurality of bypass nodes 134, 136, 138. The first terminal node 128, the second U-phase coil U2, the first bypass node 134, the first U-phase coil U1 and the neutral 126 can be connected sequentially in series. The second terminal node 130, the second V-phase coil V2, the second bypass node 136, the first V-phase coil V1 and the neutral 126 can be connected sequentially in series. The third terminal node 132, the second W-phase coil W2, the first bypass node 138, the first W-phase coil W1 and the neutral 126 can be connected sequentially in series.

The torque switching motor control system 12 can include a plurality of supply lines 140, 142, 144, a plurality of low power lines 146, 148, 150 and a plurality of high power lines 152, 154, 156.

The first supply line 140 can be electrically and physically connected to each of the motor driver 42 and the input terminal 114 of the first relay 108. The second supply line 142 can be electrically and physically connected to each of the motor driver 42 and the input terminal 114 of the second relay 110. The third supply line 144 can be electrically and physically connected to each of the motor driver 42 and the input terminal 114 of the third relay 112.

The first low power line 146 can be electrically connected to each of the first contact 116 of the first relay 108 and the first bypass node 134. The second low power line 148 can be electrically connected to each of the first contact 116 of the second relay 110 and the second bypass node 136. The third low power line 150 can be electrically connected to each of the first contact 116 of the third relay 112 and the third bypass node 138.

The first high power line 152 can be electrically connected to each of the second contact 118 of the first relay 108 and the first terminal node 128. The second high power line 154 can be electrically connected to each of the second contact 118 of the second relay 110 and the second terminal node 130. The third high power line 156 can be electrically connected to each of the second contact 116 of the third relay 112 and the third terminal node 132.

If the operator selects the low power mode with the mode selector 74, or the controller 37 determines that one or more conditions exist that are advantageous for the low power mode, the controller 37 can output the OFF signal to the relay driver 106. Upon receiving the OFF signal, the relay driver 106 can simultaneously de-energize, or continue not energizing, the relay coils 120 of all of the relays 108, 110, 112. FIG. 10 shows the position of the movable contacts 120 if the relay coils 120 are de-energized. The U-phase current will flow along the first low power line 146 and along the first U-phase coil U1, as indicated by the dashed line L. However, the second terminal 118 of the first relay 108 is electrically open. Thus, the U-phase current in the electric motor 40 will not flow through the second U-phase coil U2. The second terminal 118 of the second relay 110 and the second terminal 118 of the third relay 112 are also electrically opened. Thus, the V-phase current in the blade motor 42 will not flow through either the second V-phase coil V2 or the second W-phase coil W2.

If the operator selects the high power mode with the mode selector 74, or the controller 37 determines that one or more conditions exist that are advantageous for the high power mode, the controller 37 can output the ON signal to the relay driver 106. Upon receiving the ON signal, the relay driver 106 can simultaneously energize the relay coils 120 of all of the relays 108, 110, 112. As a result, the movable contact 120 can electrically disconnect from the first contact 116 and electrically connect the input terminal 114 to the second contact 118 and the three-phase current can flow along the high power lines 152, 154, 156 and along all of the windings U1, U2, V1, V2, W1, W2.

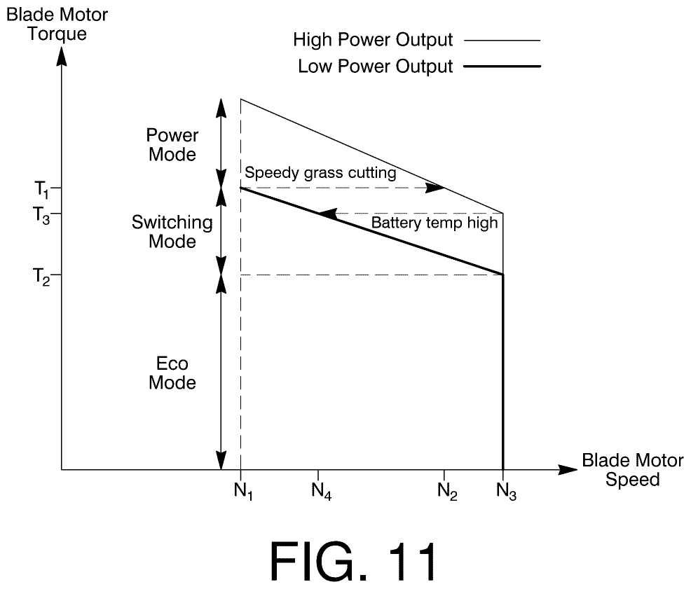

FIG. 11 illustrates two plots of blade motor torque versus blade motor speed. The first thicker plot line shows the low power output if the electric motor 40 operates in the low power mode and the second thinner plot line shows the high power output if the electric motor 40 operates in the high power mode. Generally, the torque output by the electric motor 40 can vary inversely with the rotational speed of the electric motor 40. In order to decrease the time for cutting the lawn, the operator of the lawnmower 10 can increase the speed of the electric motor 40. As shown in FIG. 11, if operator of the lawnmower 10 increases the rotational speed of the electric motor 40 from a first speed N1 to a second speed N2 that is greater than the first speed N1, then the torque output by the electric motor 40 can decrease from a first torque T1 to a second torque T2. This can adversely impact the cutting performance of the lawnmower 10 if the vegetation is thick, tall and/or damp.

Switching the electric motor 40 from the low power mode to the high power mode can provide the operator with the ability to operate electric blade motor 40 at the higher second rotational speed N2 while maintain the torque output by the electric motor 40 at or near the first torque T1. If the rotational speed of the blade 30 is increased due to the increased third speed N3 and the torque output of the electric motor 40 is maintained at or near the first torque T1, the operator can reduce the time for cutting the lawn area as compared to the time for cutting the lawn area at the slower rotational speed N1.

It is possible that operating the electric motor 40 at a high rotational speed in the high power mode can increase the temperature of the batter(ies) of the battery pack 38. The life cycle and storage capacity of a rechargeable battery can be adversely affected by relatively high temperatures. Switching the electric motor 40 from the high power mode to the low power mode can reduce the temperature of the battery(ies) of the battery pack 38. The torque switching motor control system 12 can be configured to monitor the temperature of each of the battery(ies) of the battery pack 38 and either request the operator of the lawnmower 10 to reduce the rotational speed of the electric motor 40, or automatically reduce the rotational speed of the electric motor 40 if the temperature of at least one of the batteries exceeds a predetermined threshold.

However, the power flowing out of the battery(ies) might not change since the torque output by the electric motor 40 increases as the rotational speed decreases. Thus, slowing the rotational speed of the electric motor 40 might not reduce the temperature at a rate that is expected by the operator of the lawnmower 10. If the lawnmower 10 does not have the ability to switch to a lower power output, it might be desirable to cease operation of the lawnmower 10 until such time that the battery(ies) cool down to a lower temperature. This shutdown period can be unsatisfactory for the operator of the lawnmower 10.

In contrast, switching from the high power mode to the low power mode and reducing the rotational speed of the electric motor 40 can more effectively reduce the temperature of the battery(ies) of the battery pack 38 as compared to merely slowing the rotational speed of the electric motor 40. As shown in FIG. 11, if the electric motor 40 is operating at a third speed N3 in the high power mode, the electric motor 40 can output a third torque T3. If the temperature of at least one of the battery(ies) exceeds the predetermined threshold, it can be advantageous to switch the electric motor 40 from the high power mode to the low power mode and reduce the rotational speed from the third speed N3 to a fourth speed N4 that is less than the third speed N3.

This mode switch can reduce both the rotational speed and the power output of the electric motor 40. Thus, the power flowing out of the battery(ies) can be reduced and the temperature of the battery(ies) can be reduced without ceasing operation of the lawnmower 10. Further, the torque output by the electric motor 40 can be at or near the third torque T3. Thus, the blade 30 can continue to cut the vegetation in a manner that is desirable by the operator of the lawnmower 10.

Returning to FIG. 10, the control system 28 can include a runtime selector 158. The runtime selector 158 can permit the operator of the lawnmower to set a desired time period for completing the mowing operation of the lawn area. The runtime selector 158 can be any appropriate device such as, but not limited to, a multi-position switch, a sliding knob, a rotary dial, or a touch screen, that can permit the user to set the desired time period. The runtime selector 158 can be configured to show a plurality of predetermined time periods from which to choose, or to select any time period between a minimum time period and a maximum time period. During the switching mode operation, the controller 37 can be configured to automatically switch the electric motor 40 between the high power mode and the low power mode based on the selected period, the remaining charge of the battery pack 38, and the power output by the battery pack 38. This ability of the controller 37 can promote a confidence perceived by the operator that the mowing can be completed before the battery pack 38 will be fully discharged.

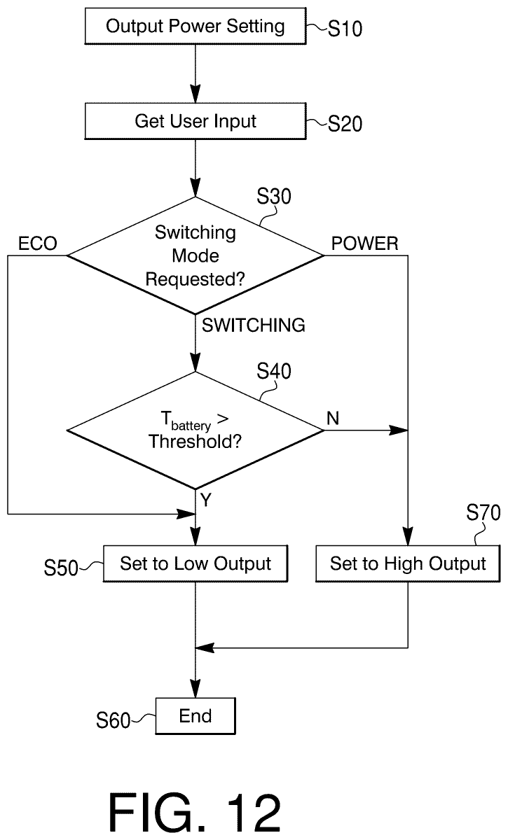

The torque switching motor control system 12 can be configured to signal the operator to switch between the low power mode and the high power mode, as needed, or configured to automatically switch between the low power mode and the high power mode. FIG. 12 illustrates a flowchart for an algorithm that can be executed by the controller 37 to either signal the operator to switch from one of the low power mode and the high power mode to another one of the low power mode and the high power mode, or automatically switch between the two modes of the electric motor 40.

At step S10, the controller 37 can be configured to initiate the power mode selection (i.e., ECO or Power) for the electric motor 40. The controller 37 can initiate step S10 in response to the operator's actuation of the wake button 70. From step S10, the controller 37 can proceed to step S20.

At step S20, the controller 37 can be configured to receive a signal from the mode selector 74 that is based on the input by the operator of the lawnmower 10. The signal output by the mode selector 74 can be indicative of the selected one of the high power mode, low power mode and switching mode. At step S20, the controller 37 can be configured to receive a signal from the temperature sensor 124 or retrieve data stored in a memory device that was output by the temperature sensor 124. From step S20, the controller 37 can proceed to step S30.

At step S30, the controller 37 can be configured to determine which mode has been selected by the operator of the lawnmower 10. If the signal received from the mode selector 74 indicates that the switching mode has been selected, the controller 37 can be configured to proceed to step S40. If the signal received from the mode selector 74 indicates that the low power mode has been selected, the controller 37 can be configured to proceed to step S50. If the signal received from the mode selector 74 indicates that the high power mode has been selected, the controller 37 can be configured to proceed to step S70.

At step S40, the controller 37 can be configured to compare the data output by the temperature sensor 124 to a predetermined threshold. If the temperature data is greater than the predetermined threshold, then the controller 37 can proceed to step S50. If the temperature data is less than or equal to the predetermined threshold, then the controller 37 can proceed to step S70.

At step S50, the controller 37 can be configured to operate the electric motor 40 in the low power mode. The controller 37 can output the OFF signal to the relay driver 106 so that the movable contacts 122 electrically connect the input terminals 114 to the first contacts 116, as shown in FIG. 10. From step S50, the controller 37 can proceed to step S60.

At step S60, the controller 37 can be configured to exit the present iteration of the output setting algorithm.

At step S70, the controller 37 can be configured to operate the electric motor 40 in the high power mode. The controller 37 can output the ON signal to the relay driver 106 so that the movable contacts 122 electrically connect the input terminals 114 to the second contacts 118. From step S70, the controller 37 can proceed to step S60.

The high power mode of the torque switching motor control system 12 can permit the operator of the lawn and garden power tool 10 to reduce the operating time to complete the task without reducing the torque applied to the implement. The low power mode of the torque switching motor control system 12 can minimize the consumption of the electric power of the battery pack 38 by the electric motor 40, if the high power mode is excessive for the task at hand. The switching mode can more effectively regulate the temperature of the battery(ies) in the battery pack 38 as well as change the power output of the electric motor based on the condition(s) of the vegetation that is to be cut. Accordingly, the torque switching motor control system 12 of the lawn and garden power tool 10 can more effectively adapt the lawn and garden power tool 10 to its operating conditions.

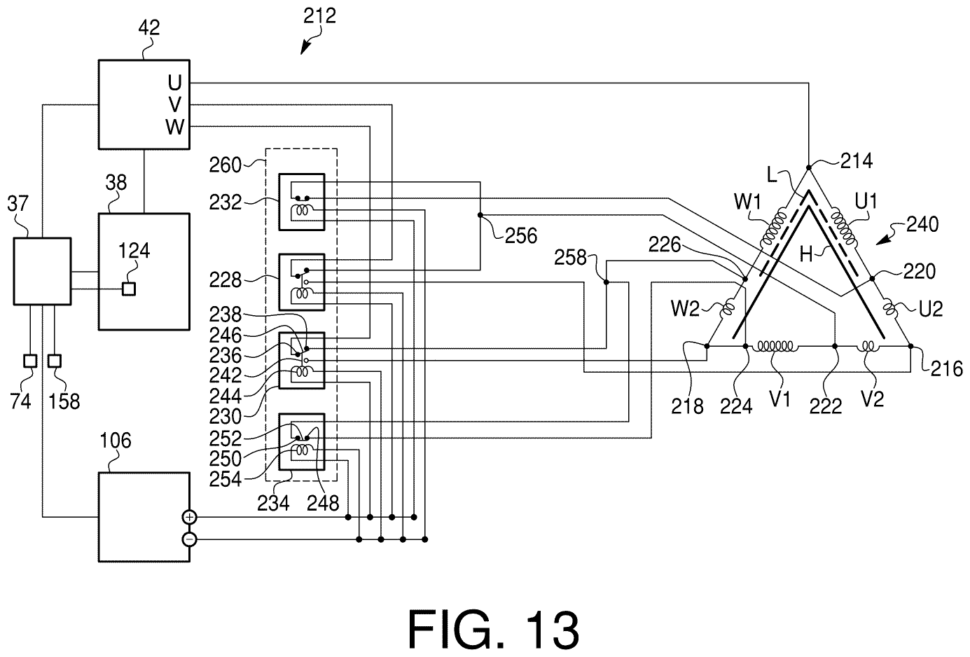

FIG. 13 schematically illustrates a first alternate embodiment of a torque switching motor control system 212 for use with the lawn and garden power tool 10 of FIG. 1.

Instead of being wired in a wye configuration, the torque switching motor control system 212 can include a 3-phase electric motor 240 that is wired in a delta configuration. FIG. 13 schematically illustrates the respective sets of windings U1, V1, W1, U2, V2, W2 shown in FIGS. 4-6 as a respective single coil U1, V1, W1, U2, V2, W2 for simplicity and clarity of the drawing.

The torque switching motor control system 212 can include a switch 260 instead of the switch 160 of FIG. 10. The torque switching motor control system 212 can be electrically connected to the motor driver 42 and can include the controller 37, the mode selector 74, the relay driver 106, the temperature sensor 124 and the runtime selector 158 described above with respect to FIGS. 1-12. The relay driver 106 can control the switch 260 based on the ON signal or the OFF signal it receives from the controller 37.

The electric motor 240 can include the windings U1, U2, V1, V2 W1, W2 described above with respect to the electric motor 40 of FIGS. 1-10 except that the windings U1, U2, V1, V2 W1, W2 are wired in the delta configuration shown in FIG. 13. The electric motor 240 can include a plurality of terminal nodes 214, 216, 218 and a plurality of bypass nodes 220, 222, 224, 226.

The switch 260 can include a plurality of relays 228, 230, 232, 234 and can be referred to as a relay array 260. Each of the first and second relays 228, 230 can be referred to as a single-pole, double-throw relay. Each of the first and second relays can include an input terminal 236, a first contact 238, a second contact 242, a relay coil 244 and a movable contact 246. The reference numbers 236, 238, 242, 244, 246 are omitted from the first relay 228 for clarity and simplicity of the drawing. Each of the third and fourth relays 232, 234 can be referred to as a single-pole, single-throw relay and can include a first terminal 248, a second terminal 250, a movable contact 252 and a relay coil 254. The reference numbers 248, 250, 252 are omitted from the third relay 232 for clarity and simplicity of the drawing. Each of the relay coils 244, 252 can be electrically connected to and selectively controlled by the relay driver 106.

The relay driver 106 can be configured to simultaneously energize the relay coil 244, 254 of all of the relays 228, 230, 232, 234 if the relay driver 106 receives the ON signal from the controller 37. The relay driver 106 can be configured to simultaneously de-energize the relay coils 244, 254 of all of the relays 228, 230, 232, 234 if the relay driver 106 receives the OFF signal from the controller 37.

Each of the relays 228, 230 can include a biasing structure that biases the respective movable contact 246 to electrically connect the respective input terminal 236 to the respective first contact 238 when the respective relay coil 244 is de-energized. The movable contact 246 can be spaced away from the second contact 242 if the coil 244 is de-energized. The movable contact 246 can disengage from the first contact 238 and electrically connect to the second contact 242 if the relay driver 106 energizes the relay coil 244. FIG. 13 shows each of the relays 228, 230 in the de-energized state.

Each of the relays 232, 234 can include a biasing structure that biases the respective movable contact 252 to electrically connect the respective terminals 248, 250 when the respective relay coil 254 is de-energized. The movable contact 252 can disengage from the terminals 248, 250 if the relay driver 106 energizes the relay coil 254.

If the coils 244, 254 are de-energized as shown in FIG. 13, current does not flow through any of the second windings U2, V2, W2 and the electric motor 240 can operate in the low power mode. If the coils 244, 254 are energized, current can flow through all of the windings U1, V1, W1, U2, V2, W2 and the electric motor 240 can operate in the high power mode.

The torque switching motor control system 212 can include a fifth bypass node 256 and a sixth bypass node 258.

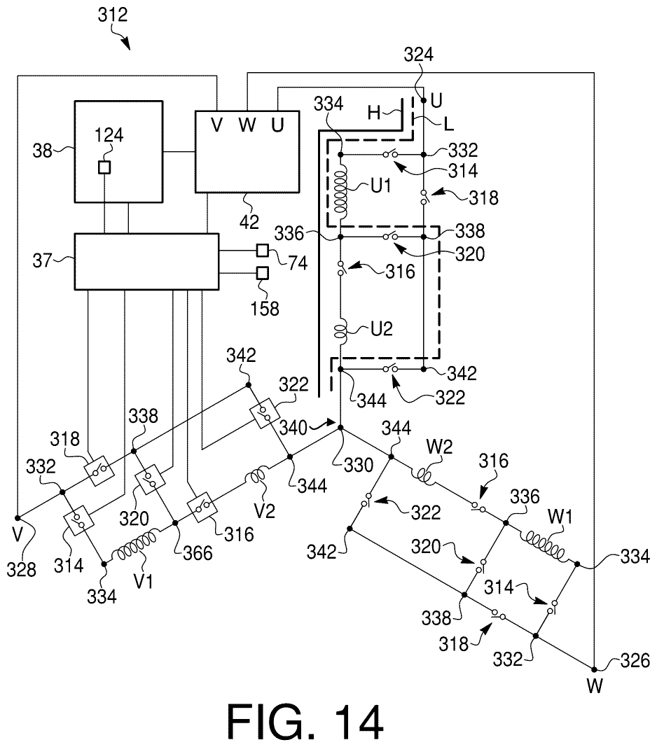

FIG. 14 schematically illustrates a second alternate embodiment of a torque switching motor control system 312 for use with the lawn and garden power tool 10 of FIG. 1. The torque switching motor control system 312 can include a 3-phase electric motor 340 that is wired in a wye configuration. FIG. 14 schematically illustrates the respective sets of windings U1, V1, W1, U2, V2, W2 shown in FIGS. 4-6 as a respective single coil U1, V1, W1, U2, V2, W2 for simplicity and clarity of the drawing.

The torque switching motor control system 312 can include a plurality of switches 314, 316, 318, 320, 322 instead of the switch 160 of FIG. 10. The torque switching motor control system 312 can be electrically connected to the motor driver 42 and can include the controller 37, the mode selector 74, the temperature sensor 124 and the runtime selector 158 described above with respect to FIGS. 1-12.

The electric motor 340 can include the windings U1, U2, V1, V2 W1, W2 described above with respect to the electric motor 40 of FIGS. 1-10. The electric motor 340 can include a plurality of terminal nodes 324, 326, 328, a neutral 330 and a plurality of bypass nodes 332, 334, 336, 338, 342 and a plurality of return nodes 344.

Each of the switches 314, 316, 318, 320, 322 can be any appropriate switching device such as, but not limited to a transistor or a single-pole, single throw relay. The switches 314, 316, 318, 320, 322 can be collectively referred to as a switch, a switch array or a relay array. The controller 37 can be configured to individually control each of the switches 314, 316, 318, 320, 322 in order to switch the electric motor 340 between the low power mode and the high power mode. The controller 37 can be configured to turn on (or close) all of the first switches 314, all of the fourth switches 320, and all of the fifth switches 322 and turn off (or open) all of the second switches 316 and all of the third switches 318 to operate the electric motor 340 in the low power mode as indicated by the dashed line L. The controller 37 can be configured to turn on (or close) all of the first switches 314 and all of the second switches 316 and turn off (or open) all of the third switches 318, all of the fourth switches 320 and all of the fifth switches 322 to operate the electric motor 340 in the high power mode as indicated by the solid line H.

The controller 37 can be configured to operate the electric motor 340 in a second low power mode in which the power output by the electric motor 340 is less than the output in the high power mode and the low power mode. To operate the electric motor 340 in the second power mode, the controller 37 can cause current output by the motor driver 42 to bypass all of the first windings U1, V1, W1 and flow through all of the second windings U2, V2, W2. The controller 37 can be configured to turn on (or close) all of the second switches 316, all of the third switches 318 and all of the fourth switches 320 and to turn off (or open) all of the first switches 314 and all of the fifth switches 322.

Returning to FIG. 2, the housing 36 can include a lower housing 60, an upper housing 62, a front lid 64 and a rear lid 66. The lower housing 60 can be mounted on the top of the cutter housing 18. The duct plate 54 can be mounted on the upper side of the lower housing 60 with respect to the Z-direction. The blade motor 40 and the fan 50 can be located inside the lower housing 60 and between the duct plate 54 and the top surface of the cutter deck 18 with respect to the Z-direction.

The upper housing 62 can be connected to the lower housing 60 and enclose the duct plate 54. The upper housing 62 can include a battery tray assembly 68 that receives the battery pack 38 and reliably secures the battery pack to the housing 36.

The rear lid 66 can be mounted onto the upper housing 62 so that the upper housing 62 and the rear lid enclose at least a portion of the battery pack 38 and the battery tray assembly 68. The front lid 64 can be connected to the rear lid 66 and the upper housing 62 so that the front lid 64 can be removed or moved between a closed position and an opened position. The front lid 64 and the upper housing 62 can enclose at least a portion of the battery pack 38 and the battery tray assembly 68 when the front lid 64 is mounted onto the upper housing 62 or placed into the closed position, as shown in FIG. 1.

The lawnmower 10 can be self-propelled by an electric propulsion motor that is powered by the transmission controller 56 via the propulsion wire harness. The propulsion motor can drive at least one of the wheels 20, 22. The propulsion motor can be a DC electric motor or an AC electric motor. The lawnmower 10 can include an input by which the user can cause the propulsion motor driver to vary the speed at which the propulsion motor moves the lawnmower 10 across the terrain.

While certain embodiments of the invention are described above, it should be understood that the invention can be embodied and configured in many different ways without departing from the spirit and scope of the invention.

Instead of the rotor 86 being inside of the stators 80, 82, alternate embodiments of the electric motors 40, 240, 340 can include a rotor 86 that is outside of and encircles the stators 80, 82. Such a configuration can be referred to as an outer rotor motor.

The exemplary embodiments described above can include the temperature sensor 124 that detects a temperature of at least one battery of the battery pack 38. Alternate embodiments can include any other appropriate sensor in lieu of or in addition to the temperature sensor 124, such as speed sensors, humidity sensors, rain sensors, ground fault sensors, etc. In an alternate embodiment, the lawn and garden power tool 10 can include a temperature sensor that can output a signal to the controller 37 that is indicative of the temperature of the electric motor 40, 240, 340. In another alternate embodiment, the lawn and garden power tool 10 can include an atmospheric temperature sensor that can output a signal to the controller 37 that is indicative of the ambient air temperature. In another alternate embodiment, the lawn and garden power tool 10 can include a sensor that can output a signal to the controller 37 that is indicative of the moisture content in or on the vegetation that is to be manicured by the lawn and garden power tool 10. In another alternate embodiment, the lawn and garden power tool 10 can include a sensor that can output a signal to the controller 37 that is indicative of the length of the vegetation that is to be manicured by the lawn and garden power tool 10.

Instead of a 3-phase AC or DC brushless motor, the electric motors 40, 240, 340 can be a single-phase AC motor or a two-phase AC motor.

Alternate embodiments can include transistors instead of any of the relays, including relays 108, 110, 112, 228, 230, 232, 234.

Exemplary embodiments can include an electric motor that can be switched between a wye configuration and a delta configuration. The lawn and garden power tool 10 can include a first switch array, such as shown in FIG. 10 or 14, for switching the motor between the low power mode or the high power mode if the motor is switched into the wye configuration, and a second switch array, such as shown in FIG. 13, for switching the motor between the low power mode or the high power mode if the motor is switched into the delta configuration.

Instead of being self-propelled, exemplary embodiments can include a lawnmower 10 that is pushed by the user without propulsion assistance by the lawnmower. As a result, the propulsion motor, the propulsion motor driver 56 and the propulsion wire harness 58 can be omitted.

Instead of being configured as a walk-behind lawnmower, exemplary embodiments of the lawn and garden power tool can include a ride-on lawnmower that includes a seat for the user to sit on or a sulky for the user to stand on. The high power and low power modes can be further divided into higher and lower power modes by adding additional coils and wiring circuits that are configured similar to those described above. In addition, the ratio of power between power modes can be different from those disclosed above, and can in addition to 1.5:1, can be 3:1, 1:1, 4:1, 0.5:1 and others.

What is claimed is:

1. A lawn and garden power tool, comprising:
a battery;
an electric motor including:
a housing;
a rotor supported by the housing and rotatable relative to the housing about a rotational axis;
a first stator core fixed to the housing and located about the rotor;
a first coil wound on the first stator core;
a second stator core fixed to the housing, located about the rotor, and stacked relative to the first stator core along the rotational axis;
a second coil wound on the second stator core;
a shaft connected to and driven by the rotor;
an implement driven by the shaft; and
a controller in electrical communication with the battery and configured to:
if the controller receives a first operational request, cause the motor to operate in a first output mode in which the battery pack is electrically connected to the first coil and the second coil, and the first coil is electrically connected in series with the second coil; and
if the controller receives a second operational request that is different from the first operational request, cause the motor to operate in a second output mode in which the battery pack is electrically disconnected from the second coil and electrically connected to the first coil.

2. The lawn and garden power tool according to claim 1, wherein the controller is configured to:
cause the motor to operate in the first output mode if:
the controller receives a third operational request that is different from the first operational request and the second operational request; and
a temperature of the battery is less than or equal to a predetermined threshold; and
cause the motor to operate in the second output mode if:
the controller receives the third operational request; and
the temperature of the battery is greater than the predetermined threshold.

3. The lawn and garden power tool according to claim 2, further comprising:
a switch in electrical communication with each of the battery and the controller, wherein
the controller is configured to:
signal the switch to connect the battery, the first coil, and the second coil in series if the controller receives the first operational request; and
signal the switch to disconnect the battery from the second coil and electrically connect the battery to the first coil if the controller receives the second operational request.

4. The lawn and garden power tool according to claim 3, wherein the controller is configured to:
signal the switch to connect the battery, the first coil, and the second coil in series if:
the controller receives the third operational request that is different from the first operational request and the second operational request; and
the temperature of the battery is less than or equal to the predetermined threshold;
signal the switch to disconnect the battery from the second coil and electrically connect the battery to the first coil if:
the controller receives the third operational request; and
the temperature is greater than the predetermined threshold.

5. The lawn and garden power tool system according to claim 4, wherein the switch includes a plurality of single-pole double-throw relays.

6. The lawn and garden power tool according to claim 5, further comprising:
a motor driver in electrical communication with the controller and configured to receive a DC power input from the battery, convert the DC power to AC power, and output the AC power to the switch; and
a relay driver in electrical communication with the controller and the switch, wherein
the controller is configured to vary a relay signal based on the temperature and a received one of the first operational request, the second operational request, and the third operational request, and
the relay driver is configured to cause the switch to selectively connect and disconnect electrical communication between the battery and the second coil based on the relay signal received from the controller.

7. The lawn and garden power tool according to claim 2, further comprising:
a user input configured to permit a user of the power tool to select one of the first operational request, the second operational request, and the third operational request.

8. The lawn and garden power tool according to claim 1, wherein the implement is a cutting blade.

9. The lawn and garden power tool according to claim 8, further comprising:
a mower deck including a cutting chamber; and
a plurality of wheels mounted on the mower deck, wherein
the cutting blade is mounted onto the shaft and rotatable inside the cutting chamber.

10. The lawn and garden power tool according to claim 9, further comprising:
a handle connected to and extending away from the mower deck; and
a user input mounted on the handle and configured to permit the user to select any one of the first operational request, the second operational request, and a third operational request that is different from the first operational request and the second operational request, wherein
the controller is configured to:
cause the motor to operate in the first output mode if:
the controller receives the third operational request; and
a temperature of the battery is less than or equal to a predetermined threshold; and
cause the motor to operate in the second output mode if:
the controller receives the third operational request; and
the temperature of the battery is greater than the predetermined threshold.

11. A lawn and garden power tool, comprising:
a battery;
an electric motor including:
a housing;
a rotor supported by the housing and rotatable relative to the housing about a rotational axis;
a first stator core fixed to the housing and located about the rotor;
a first coil wound on the first stator core;
a second stator core fixed to the housing, located about the rotor, and stacked relative to the first stator core along the rotational axis;
a second coil wound on the second stator core;
a shaft connected to and driven by the rotor and configured to drive an implement;
a user input configured to output a selected one of a first operational request, a second operational request, and a third operational request; and
a controller in electrical communication with the battery and configured to:
if the controller receives the first operational request, cause the electric motor to operate in a first output mode in which the battery pack is electrically connected in to the first coil and the second coil, and the first coil is electrically connected in series with the second coil;
if the controller receives the second operational request that is different from the first operational request, cause the electric motor to operate in a second output mode in which the battery pack is electrically disconnected from the second coil and electrically connected to the first coil; and
if the controller receives the third operational request that is different from the first operational request and the second operational request, cause the electric motor to:
operate in the first output mode if a sensed variable has a first relationship to a predetermined threshold; and
operate in the second output mode if the sensed variable has a second relationship to the predetermined threshold, the second relationship is different from the first relationship.

12. The lawn and garden power tool according to claim 11, further comprising:
a motor driver electrically connected to the battery and the controller, and configured to convert a DC power input received from the battery into three-phase back electromotive force (Back EMF) or AC power; and
a switch electrically connected to each of the controller, the motor driver, and the electric motor, and configured to receive the AC power from the motor driver and selectively distribute the AC power to the electric motor such that the electric motor operates in one of the first output mode and the second output mode, wherein
the sensed variable is a temperature of the battery,
the first relationship includes the temperature being less than or equal to the predetermined threshold, and
the second relationship includes the temperature being greater than the predetermined threshold.

13. The lawn and garden power tool according to claim 11, wherein
the electric motor is a three-phase AC electric or DC brushless motor,
the first coil includes a plurality of first windings wired in a wye configuration,
the second coil includes a plurality of second windings wired in a wye configuration, and
the switch includes:
a first relay configured to selectively connect a respective one of the first windings in series with a respective one of the second windings, a second relay configured to selectively connect a respective one of the first windings in series with a respective one of the second windings, and a third relay configured to selectively connect a respective one of the first windings in series with a respective one of the second windings.

14. The lawn and garden power tool according to claim 11, wherein
the electric motor is a three-phase AC electric or DC brushless motor,
the first coil includes a plurality of first windings wired in a delta configuration,
the second coil includes a plurality of first windings wired in a delta configuration and
the switch includes a first relay, a second relay, a third relay and a fourth relay,
the first coil is connected in series with second coil if all of the first relay, the second relay, the third relay, and the fourth relay are energized, and
the second coil is electrically disconnected from the first coil if all of the first relay, the second relay, the third relay, and the fourth relay are de-energized.

15. The lawn and garden power tool system according to claim 14, wherein
each of the first relay and the second relay is a single-pole, double-throw relay, and
each of the third relay and the fourth relay is a single-pole, single-throw relay.

16. A lawn and garden power tool, comprising:
a battery;
an electric motor including:
a housing;
a rotor located adjacent the housing and rotatable relative to the housing about a rotational axis;
a first stator core located about the rotor;
a first coil wound on the first stator;
a second stator core located about the rotor, and stacked relative to the first stator core along the rotational axis such that the first stator is located at a first position along the rotational axis and the second stator core is located at a second position different from the first position along with rotational axis;
a second coil wound on the second stator core;
a shaft connected to and driven by the rotor and configured to drive an implement; and
a controller in electrical communication with the battery and configured to:
if the controller is subject to a first operational request, cause the motor to operate in a high power mode in which the battery pack is electrically connected to the first coil and the second coil; and
if the controller is subject to a second operational request that is different from the first operational request, cause the motor to operate in a low power mode in which the battery pack is electrically disconnected from the second coil and electrically connected to the first coil.

17. The lawn and garden power tool according to claim 16, wherein
a power rating for the first coil is different than a power rating for the second coil.

18. The lawn and garden power tool according to claim 16, wherein the shaft is connected to the implement and the implement is configured as a lawn mowing blade.

19. The lawn and garden power tool according to claim 16, further comprising:
a sensor, wherein the first operational request and second operational request are determined based on information received from the sensor.

20. The lawn and garden power tool according to claim 19, wherein the sensor is configured to determine one of: a temperature of the electric motor; an atmospheric temperature; a lawn dampness; and a lawn length.
